(19) United States
(12) Patent Application Publication
(10) Pub. No.: US 2014/0019416 A1
(43) Pub. Date: Jan. 16, 2014

(54) MOBILE POWER SUPPLY WITH DATA BACKUP FUNCTION AND DATA RECOVERY METHOD THEREOF

(71) Applicant: ASKEY COMPUTER CORP., New Taipei City (TW)

(72) Inventors: Ming-Seng CHANG, New Taipei City (TW); Yu-Wei SHU, New Taipei City (TW)

(73) Assignee: ASKEY COMPUTER CORP., New Taipei City (TW)

(21) Appl. No.: 13/672,765

(22) Filed: Nov. 9, 2012

(30) Foreign Application Priority Data
Jul. 13, 2012 (TW) 101125289

(51) Int. Cl. G06F 11/14

(52) U.S. Cl. CPC G06F 11/1458
USPC 707/647

(57) ABSTRACT

A mobile power supply with a data backup function and a data recovery method thereof are introduced. The mobile power supply supplies power to a portable electronic device installed with an Android operating system via a USB port. The mobile power supply copies a predetermined datum from the portable electronic device to a memory unit in the mobile power supply in conjunction with a control unit to perform first-stage data backup. Then, the USB port is electrically connected to a computer apparatus, such that the computer apparatus copies the predetermined datum from the memory unit to the computer apparatus while recharging the mobile power supply to perform second-stage data backup. Accordingly, the portable electronic device or the mobile power supply performs a data backup operation easily and quickly while being recharged.

### CROSS-REFERENCE TO RELATED APPLICATION

This non-provisional application claims priority under 35 U.S.C. §119(a) on Patent Application No(s). 101125289 filed in Taiwan, R.O.C. on Jul. 13, 2012, the entire contents of which are hereby incorporated by reference.

### FIELD OF TECHNOLOGY

The present invention relates to data recovery devices and data recovery methods, and more particularly, to a mobile power supply with a data backup function and a data recovery method thereof.

### BACKGROUND

Due to the rapid development of portable electronic devices, various peripheral devices are emerging. One of the examples of new peripheral devices is a mobile power supply that supplies a charging power to portable electronic devices in real time.

Portable electronic devices are becoming more robust and thus consume an increasingly large amount of power. Hence, it is imperative to ensure that the portable electronic devices operating outdoors are sufficiently powered. To this end, the prior art requires that portable electronic device users should have a standby battery or a mobile power supply at hand. In this regard, a mobile power supply excels a standby battery in the scope of application. It is because a mobile power supply is suitable for a wide variety of portable electronic devices.

Data backup is one of the functions of a typical portable electronic device. A conventional portable electronic device has to be connected to a computer apparatus in order to perform synchronous data backup, and in consequence is prevented from achieving real-time synchronous data backup.

Accordingly, it is imperative to enhance the ease of use of portable electronic devices by integrating the functions thereof with each other.

### SUMMARY

It is an objective of the present invention to provide a portable electronic device that performs data backup conveniently, automatically, and quickly. Another objective of the present invention is to add a data backup function to a widely-used conventional mobile charging function so as to provide a mobile power supply capable of performing data backup.

In order to achieve the above and other objectives, the present invention provides a mobile power supply having a data backup function. The mobile power supply comprises a battery unit and a USB port. The battery unit supplies power to a portable electronic device installed with an Android operating system via the USB port. The present invention is characterized in that the mobile power supply further comprises: a control unit connected to the USB port, wherein, once the portable electronic device is connected to the USB port, a communication connection will be created between the control unit and the portable electronic device via an open accessory interface disposed in the Android operating system and adapted to support an open accessory protocol, such that the control unit copies a predetermined datum from the portable electronic device to a storage unit; and the storage unit connected to the control unit for storing the predetermined datum.

In an embodiment, with the mobile power supply being connected to the portable electronic device, the control unit enables the mobile power supply to operate in the accessory mode of an open accessory protocol-enabled technology, such that the predetermined datum is copied from the portable electronic device to the storage unit by a computer backup configuration program installed on the Android operating system of the portable electronic device. When the computer backup configuration program is not installed on the Android operating system of the portable electronic device, the control unit causes the portable electronic device to download a computer backup configuration program-specific Android package from an Android market online and install the computer backup configuration program.

In an embodiment, when the Android operating system does not support the open accessory protocol-enabled technology, the control unit does not perform a data backup operation on the predetermined datum, such that the mobile power supply merely supplies power to the portable electronic device.

In an embodiment, when the control unit is connected to a computer apparatus not installed with the Android operating system, the control unit operates in a slave mode under a USB protocol, such that the computer backup configuration program installed on the computer apparatus can copy the predetermined datum from the storage unit of the mobile power supply to the computer apparatus.

In order to achieve the above and other objectives, the present invention further provides a data recovery method for use with a mobile power supply, the mobile power supply supplying power to a portable electronic device installed with an Android operating system via a USB port, thereby allowing a data backup operation to be performed on a predetermined datum in the portable electronic device by a memory unit of the mobile power supply. The data recovery method comprises the steps of: (a1) creating electrical connection between the USB port of the mobile power supply and the portable electronic device for charging the portable electronic device; (a2) creating communication connection between the mobile power supply and an open accessory interface in the Android operating system of the portable electronic device; and (a3) copying, with a computer backup configuration program installed on the Android operating system of the portable electronic device, the predetermined datum from the portable electronic device to the memory unit so as to perform a data backup operation on the predetermined datum.

In an embodiment, the method further comprises, prior to step (a1), configuring a datum, which is stored in the portable electronic device and intended for data backup, as the predetermined datum with the computer backup configuration program.

In an embodiment, step (a2) further comprises the sub-steps of: (a21) determining whether the Android operating system of the portable electronic device supports an open accessory protocol-enabled technology, going to step (a22) when the determination is affirmative and the mobile power supply operates in an accessory mode relative to the portable electronic device, and merely supplying power to the portable electronic device when the determination is negative; and (a22) determining whether the computer backup configuration program is installed on the Android operating system of the portable electronic device, going to step (a3) when the determination is affirmative, and controlling the portable electronic device to download a computer backup configuration program-specific Android package from an Android market online, installing the computer backup configuration program, and going back to step (a3), when the determination is negative.

In an embodiment, the method further comprises the steps of: (b1) electrically connecting the USB port of the mobile power supply to a computer apparatus not installed with the Android operating system, so as for the computer apparatus to charge the mobile power supply and for the mobile power supply to operate in a slave mode under the USB protocol relative to the operation mode of the computer apparatus; and (b2) copying the predetermined datum from the storage unit of the mobile power supply to the computer apparatus by the computer apparatus in the slave mode and with a computer backup configuration program installed on the computer apparatus.

Accordingly, a real-time data backup function is integrated with a power supply function of a mobile power by means of an Android open operating system that supports an Open Accessory Protocol-enabled technology, so as to enhance ease of use, enable real-time data backup, and meet a user need of multifunction integration.

### BRIEF DESCRIPTION OF THE DRAWINGS

Objectives, features, and advantages of the present invention are hereunder illustrated with specific embodiments in conjunction with the accompanying drawings, in which:

FIG. 1 is a function block diagram of a mobile power supply with a data backup function according to an embodiment of the present invention;

FIG. 2 is a flow chart of a data recovery method for performing data backup with a mobile power supply according to an embodiment of the present invention;

FIG. 3 is a detailed flow chart of step (a2) in FIG. 2; and

FIG. 4 is a flow chart of the data recovery method performed with the mobile power supply connected to a computer apparatus according to another embodiment of the present invention.

### DETAILED DESCRIPTION

In an embodiment of the present invention, given a version of an Android open operating system that supports Android Open Accessory Protocol, such as version 2.3.4 for use with smart phones and later Android operating system versions thereof, version 3.1 for use with tablet computers and later Android operating system versions thereof, an external USB-equipped device can interact with a handheld electronic device installed with any aforesaid version of Android open operating system through an Android Open Accessory interface (API) and a dedicated accessory mode.

In an embodiment of the present invention, given the development of a dedicated program for use with a computer backup configuration program, it is feasible to configure a predetermined datum stored in a handheld electronic device and intended for backup, and then copy the predetermined datum to a mobile power supply in a subsequent control step and thereby finish the first-stage data backup process. During the second-stage data backup process, with a Universal Serial Bus Protocol being executed in a master slave mode, a computer apparatus functioning as a host, a mobile power supply functioning as a client, it is feasible to copy the predetermined datum from the client to the host, using a dedicated program of a computer backup configuration program, thereby finalizing the second-stage data backup.

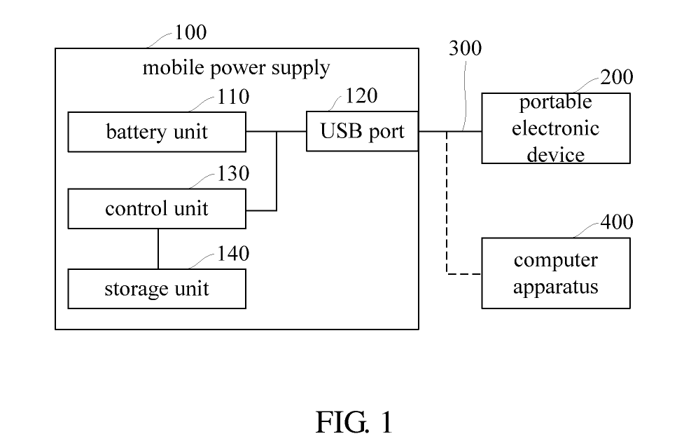

Referring to FIG. 1, there is shown a function block diagram of a mobile power supply 100 with a data backup function according to an embodiment of the present invention. The mobile power supply 100 comprises a battery unit 110, a USB (Universal Serial Bus) port 120, a control unit 130, and a storage unit 140. The mobile power supply 100 supplies power to a portable electronic device 200 installed with Android operating system, using the battery unit 110 and the USB port 120. The USB port 120 is connected to a USB port (not shown) of the portable electronic device 200 via a USB connection cable 300.

The battery unit 110 is disposed inside the mobile power supply 100. The battery unit 110 is a rechargeable battery fixed to the mobile power supply 100. Alternatively, the battery unit 110 is a replaceable rechargeable battery. Alternatively, the battery unit 110 is a battery which is not rechargeable.

Referring to FIG. 1, the control unit 130 is connected to the USB port 120. Once the portable electronic device 200 is connected to the mobile power supply 100 via the USB port 120, a communication connection will be created between the control unit 130 and the portable electronic device 200 via an Open Accessory interface (API) disposed in the Android operating system and adapted to support the Open Accessory Protocol, such that the control unit 130 copies a predetermined datum from the portable electronic device 200 to the storage unit 140. The storage unit 140 is connected to the control unit 130 for storing the predetermined datum.

In an embodiment, with the mobile power supply 100 being connected to the portable electronic device 200, the control unit 130 enables the mobile power supply 100 to operate in the accessory mode of the Open Accessory Protocol-enabled technology. In the accessory mode, the mobile power supply 100 functions as a host, whereas the portable electronic device 200 functions as a client. The host dominates the client. Hence, the mobile power supply 100 is capable of copying the predetermined datum from the portable electronic device 200 to the storage unit 140 by means of the computer backup configuration program installed on the Android operating system of the portable electronic device 200, thereby allowing a user to determine by means of the computer backup configuration program a default datum that needs to undergo backup.

In the situation where the computer backup configuration program is not installed on the Android operating system of the portable electronic device 200, the control unit 130 controls the portable electronic device 200 to download a computer backup configuration program-specific Android package from the Android market online and install the computer backup configuration program.

In the situation where the Android operating system does not support the Open Accessory Protocol-enabled technology, for example, in case of a pre-2.3.4 version of the Android operating system operating on a smart phone or a pre-3.1 version of the Android operating system operating on a tablet computer, the control unit 130 does not perform a data backup operation on the predetermined datum, such that the mobile power supply 100 merely supplies power to the portable electronic device 200 for carrying out a charging operation only.

During the second-stage data backup, when the control unit 130 is connected to a computer apparatus 400 not installed with the Android operating system, the control unit 130 operates in a slave mode under a USB protocol, such that the computer backup configuration program installed on the computer apparatus 400 can copy the predetermined datum from the storage unit 140 of the mobile power supply 100 to the computer apparatus 400, The mobile power supply 100 is always able to allow a charging operation to be performed by the battery unit 110, using a USB port of the computer apparatus 400, such that synchronous backup of the predetermined datum can occur. With the computer apparatus 400 being a host, the computer apparatus 400 can control the mobile power supply 100 through the computer backup configuration program, so as to perform the synchronous data backup operation. In the embodiment illustrated with FIG. 1, the mobile power supply 100 is electrically connected to the handheld electronic device 200 and the computer apparatus 400 via the same USB port. Persons skilled in the art should understand that the present invention is applicable to variation of the quantity of the USB ports.

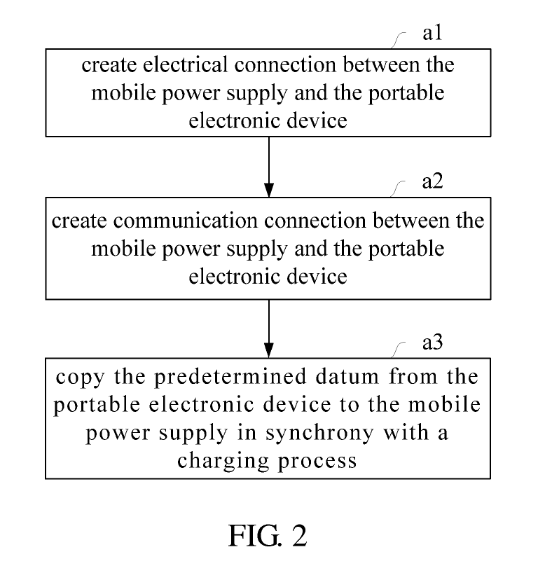

Referring to FIG. 2, there is shown a flow chart of a data recovery method for performing data backup with a mobile power supply according to an embodiment of the present invention. The data recovery method in this embodiment comprises the following steps.

First, step (a1): create electrical connection between the mobile power supply 100 and the portable electronic device 200. The purpose of step (a1) is to allow the mobile power supply 100 to charge the portable electronic device 200 when electrical connection between the USB port 100 of the mobile power supply 100 and the portable electronic device 200 is created.

Then, step (a2): create communication connection between the mobile power supply 100 and the portable electronic device 200. The purpose of step (a2) is to create communication connection between the mobile power supply 100 and an open accessory interface in the Android operating system of the portable electronic device 200.

Finally, step (a3): copy the predetermined datum from the portable electronic device 200 to the mobile power supply 100 while a charging process is underway. The purpose of step (a3) is to allow a computer backup configuration program installed on the Android operating system of the portable electronic device 200 to copy the predetermined datum from the portable electronic device 200 to the memory unit 140, so as to perform the first-stage data backup of the predetermined datum.

As regards the predetermined datum, as mentioned earlier, prior to step (a1), the data recovery method further comprises the step (not shown) of configuring a datum, which is stored in the portable electronic device and intended for data backup, as the predetermined datum by means of the computer backup configuration program.

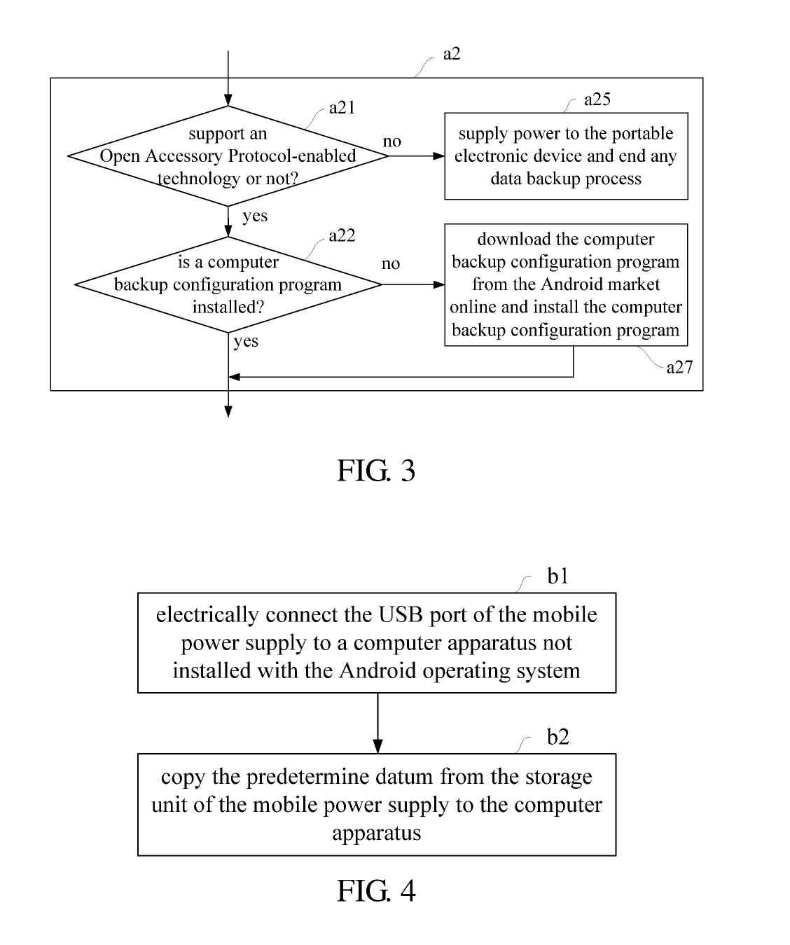

Referring to FIG. 3, there is shown a detailed flow chart of step (a2) in FIG. 2. As shown in the diagram, step (a2) further comprises the following sub-steps.

Sub-step (a21): determine whether the Android operating system of the portable electronic device 200 supports an Open Accessory Protocol-enabled technology, go to step (a22) when the determination is affirmative and the mobile power supply 100 operates in an accessory mode relative to the portable electronic device 200, and go to step (a25) when the determination is negative.

Sub-step (a25): supply power to the portable electronic device 100 without performing any data backup process.

Sub-step (a22): determine whether the computer backup configuration program is installed on the Android operating system of the portable electronic device 100, go to step (a3) when the determination is affirmative, and go to step (a27) when the determination is negative.

Sub-step (a27): control the portable electronic device 200 to download a computer backup configuration program-specific Android package from the Android market online and install the computer backup configuration program. Sub-step (a27) is followed by step (a3).

Referring to FIG. 4, there is shown a flow chart of the data recovery method performed with the mobile power supply connected to a computer apparatus according to another embodiment of the present invention. As shown in the diagram, the data recovery method in this embodiment comprises the following steps:

First, step (b1): the USB port 300 of the mobile power supply 100 is electrically connected to a computer apparatus 400 not installed with the Android operating system, so as for the computer apparatus 400 to charge the mobile power supply 100 and for the mobile power supply 100 to operate in a slave mode under the USB protocol relative to the operation mode of the computer apparatus 400.

Finally, step (b2): the computer apparatus 400 copies the predetermine datum from the storage unit 140 of the mobile power supply 100 to the computer apparatus 400 in the slave mode and with a computer backup configuration program installed on the computer apparatus 400.

In conclusion, in the embodiments of the present invention, a charging process is accompanied by data backup synchronously and automatically to thereby provide a safe and convenient data recovery method and a mobile power supply with a data backup function.

The present invention is disclosed above by preferred embodiments. However, persons skilled in the art should understand that the preferred embodiments are illustrative of the present invention only, but should not be interpreted as restrictive of the scope of the present invention. Hence, all equivalent modifications and replacements made to the aforesaid embodiments should fall within the scope of the present invention. Accordingly, the legal protection for the present invention should be defined by the appended claims.

What is claimed is:

1. A mobile power supply with a data backup function, the mobile power supply comprising a battery unit and a USB port, the battery unit supplying power to a portable electronic device installed with an Android operating system via the USB port, characterized in that the mobile power supply further comprises:
a control unit connected to the USB port, wherein, once the portable electronic device is connected to the USB port, a communication connection will be created between the control unit and the portable electronic device via an open accessory interface disposed in the Android operating system and adapted to support an open accessory protocol, such that the control unit copies a predetermined datum from the portable electronic device to a storage unit; and
the storage unit connected to the control unit for storing the predetermined datum.

2. The mobile power supply of claim 1, wherein, with the mobile power supply being connected to the portable electronic device, the control unit enables the mobile power supply to operate in the accessory mode of an open accessory protocol-enabled technology, such that the predetermined datum is copied from the portable electronic device to the storage unit by a computer backup configuration program installed on the Android operating system of the portable electronic device.

3. The mobile power supply of claim 2, wherein, when the computer backup configuration program is not installed on the Android operating system of the portable electronic device, the control unit causes the portable electronic device to download a computer backup configuration program-specific Android package from an Android market online and install the computer backup configuration program.

4. The mobile power supply of claim 1, wherein, when the Android operating system does not support the open accessory protocol-enabled technology, the control unit does not perform a data backup operation on the predetermined datum, such that the mobile power supply merely supplies power to the portable electronic device.

5. The mobile power supply of claim 1, wherein, when the control unit is connected to a computer apparatus not installed with the Android operating system, the control unit operates in a slave mode under a USB protocol, such that the computer backup configuration program installed on the computer apparatus can copy the predetermined datum from the storage unit of the mobile power supply to the computer apparatus.

6. A data recovery method for use with a mobile power supply, the mobile power supply supplying power to a portable electronic device installed with an Android operating system via a USB port, thereby allowing a data backup operation to be performed on a predetermined datum in the portable electronic device by a memory unit of the mobile power supply, the data recovery method comprising the steps of:
(a1) creating electrical connection between the USB port of the mobile power supply and the portable electronic device for charging the portable electronic device;
(a2) creating communication connection between the mobile power supply and an open accessory interface in the Android operating system of the portable electronic device; and
(a3) copying, with a computer backup configuration program installed on the Android operating system of the portable electronic device, the predetermined datum from the portable electronic device to the memory unit so as to perform a data backup operation on the predetermined datum.

7. The method of claim 6, further comprising, prior to step (a1), configuring a datum, which is stored in the portable electronic device and intended for data backup, as the predetermined datum with the computer backup configuration program.

8. The method of claim 6, wherein step (a2) further comprises the sub-steps of:
(a21) determining whether the Android operating system of the portable electronic device supports an open accessory protocol-enabled technology, going to step (a22) when the determination is affirmative and the mobile power supply operates in an accessory mode relative to the portable electronic device, and merely supplying power to the portable electronic device when the determination is negative; and
(a22) determining whether the computer backup configuration program is installed on the Android operating system of the portable electronic device, going to step (a3) when the determination is affirmative, and controlling the portable electronic device to download a computer backup configuration program-specific Android package from an Android market online, installing the computer backup configuration program, and going back to step (a3), when the determination is negative.

9. The method of claim 6, further comprising the steps of:
(b1) electrically connecting the USB port of the mobile power supply to a computer apparatus not installed with the Android operating system, so as for the computer apparatus to charge the mobile power supply and for the mobile power supply to operate in a slave mode under the USB protocol relative to the operation mode of the computer apparatus; and
(b2) copying the predetermined datum from the storage unit of the mobile power supply to the computer apparatus by the computer apparatus in the slave mode and with a computer backup configuration program installed on the computer apparatus.
